(19) United States
(12) Patent Application Publication
(10) Pub. No.: US 2021/0350366 A1
(43) Pub. Date: Nov. 11, 2021

(54) APPLICATION QUEUE API WITH DATABASE OF VIRTUAL QUEUES FOR REAL-TIME PROCESSING DISTRIBUTED LEDGER SYSTEM

(71) Applicant: RAJEEV GUPTA, Pleasanton, CA (US)

(72) Inventor: RAJEEV GUPTA, Pleasanton, CA (US)

(21) Appl. No.: 17/176,177

(22) Filed: Feb. 15, 2021

Related U.S. Application Data
(63) Continuation-in-part of application No. 16/458,189, filed on Jul. 1, 2019.
Application No. 16/458,189 is a continuation-in-part of application No. 16/392,596, filed on Apr. 23, 2019.
(60) Provisional application No. 62/661,085, filed on Apr. 23, 2018.

(51) Int. Cl. G06Q 20/40; G06F 9/54; G06F 16/27; G06Q 20/36

(52) U.S. Cl. CPC G06Q 20/401; G06F 9/546; G06Q 2220/00; G06Q 20/36; G06F 16/27

(57) ABSTRACT

In one aspect, A system for processing a real-time resource transfer using distributed ledger technology utilizing an application queue application programming interface (API) and a database virtual queues is provided. The system includes a first entity node. The first entity node includes a first processor; a first communication interface; and a first memory having a portion of a blockchain application stored. The first memory includes the blockchain application that includes a blockchain with a plurality of data records. The blockchain application, when executed by the processor, causes the processor to do the following steps. It generates a blockchain event related to the users banking account details. It maintains in the blockchain a running log of events comprising the blockchain event. A second entity node includes a second processor; a second communication interface; and a second memory having an application queue API module stored therein.

### CROSS-REFERENCE TO RELATED APPLICATIONS

This application is a continuation of and claims priority to U.S. patent application Ser. No. 16/392,596, titled SECURITY-BACKED CRYPTOCURRENCY METHODS AND SYSTEMS and filed on 23 Apr. 2019. U.S. application Ser. No. 16/392,596 claims priority from U.S. provisional patent application No. 62/661,085, titled SECURITY-BACKED CRYPTOCURRENCY METHODS AND SYSTEMS and filed on 23 Apr. 2018. This application is hereby incorporated by reference in its entirety. U.S. patent application Ser. No. 16/458,189 filed on 7 Jul. 2019 in hereby incorporated by reference in its entirety.

### BACKGROUND

### 1. Field

This application relates generally to application programming interfaces and database virtual queueing, and more particularly to a system, method, and article of manufacture of application queue API with database of virtual queues for real-time processing distributed ledger system.

### 2. Related Art

Cryptocurrencies have increased in popularity in recent years. One issue faced by cryptocurrencies is their possible volatility. Various methods are used to control this volatility. However, until now, these efforts have failed. At the same time, various securities are security is a tradable financial asset that many investors traditionally trust as an investment. Accordingly, improvements to security-backed cryptocurrency generation and management are desired.

### SUMMARY OF THE INVENTION

In one aspect, A system for processing a real-time resource transfer using distributed ledger technology utilizing an application queue application programming interface (API) and a database virtual queues is provided. The system includes a first entity node. The first entity node includes a first processor; a first communication interface; and a first memory having a portion of a blockchain application stored. The first memory includes the blockchain application that includes a blockchain with a plurality of data records. The blockchain application, when executed by the processor, causes the processor to do the following steps. It generates a blockchain event related to the users banking account details. It maintains in the blockchain a running log of events comprising the blockchain event. A second entity node includes a second processor; a second communication interface; and a second memory having an application queue API module stored therein. The application queue API module, when executed by the processor, causes the processor to implement the following steps. It provides an API available to the first communication interface of the first entity node comprising the blockchain; subscribe to the log of blockchain events, via the first communication interface. It, with the application queue API module, translates the blockchain event into a standardized data interchange format version of the block chain event. It stores the standardized data interchange format version of the block chain event in a database of virtual queues accessible by an external computing entity via the second interface.

### BRIEF DESCRIPTION OF THE DRAWINGS

The present application can be best understood by reference to the following description taken in conjunction with the accompanying figures, in which like parts may be referred to by like numerals.

FIG. 1 schematically depicts a security-backed cryptocurrency process, according to some embodiments.

FIGS. 2A-B illustrate an example process of a SECURECOIN flow in a centralized and/or decentralized trading network, according to some embodiments.

FIG. 3 illustrates an example process for implementing a stop loss order on a secure token/coin (e.g. SECURECOIN, etc.), according to some embodiments.

FIG. 4 illustrates an example process for implementing a blockchain workflow engine, according to some embodiments.

FIGS. 5A-B illustrate an example process for implementing blockchain ERP integration, according to some embodiments.

FIG. 6 illustrates an example application Queue API module, according to some embodiments.

FIG. 7 illustrate an example JSON structure for transferring a blockchain event via an application Queue API, according to some embodiments.

FIG. 8 illustrates an example process for implementing an application queue API, according to some embodiments.

FIG. 9 is a block diagram of a sample computing environment that can be utilized to implement some embodiments.

The Figures described above are a representative set and are not an exhaustive with respect to embodying the invention.

### DESCRIPTION

Disclosed are a system, method, and article of a security-backed cryptocurrency blockchain. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Application programming interface (API) is a computing interface that defines interactions between multiple software intermediaries. An API can define the kinds of calls or requests that can be made by various computer-based entities, how to make the calls, the data formats that should be used for said calls, the conventions to follow for said calls, etc. An API can also provide extension mechanisms so that users can extend existing functionality in various ways and to varying degrees. An API can be entirely custom, specific to a component, and/or designed based on an industry-standard to ensure interoperability. An API can enable modular programming, allowing users to use the interface independently of the implementation.

Blockchain is a continuously growing list of records, called blocks, which are linked and secured using cryptography. Each block typically contains a cryptographic hash of the previous block, a timestamp and transaction data.

Cryptocurrency can be a digital asset designed to work as a medium of exchange that uses cryptography to secure its transactions, to control the creation of additional units, and to verify the transfer of assets.

Delegated proof-of-stake (DPoS) works using witnesses, who generate blocks. Witnesses are elected by stakeholders at a rate of one vote per share per witness.

Electronic data interchange (EDI) enables electronically communicating information that was traditionally communicated on paper, such as purchase orders and invoices.

Enterprise resource planning (ERP) is the integrated management of core business processes, often in real-time and mediated by software and technology.

JSON (JavaScript Object Notation) is an open standard file format, and data interchange format, that uses human-readable text to store and transmit data objects consisting of attribute-value pairs and array data types (and/or any other serializable value). JSON is a common data format.

Ethereum is a decentralized, open-source blockchain featuring smart contract functionality. Ether (ETH) is the native cryptocurrency of the platform.

Various blockchain consensus algorithms can be utilized. Proof-of-authority (PoA) is an algorithm used with blockchains that delivers comparatively fast transactions through a consensus mechanism based on identity as a stake. PoA uses identity as the sole verification of the authority to validate, meaning that there is no need to use mining. With PoA, the appointment of an authority is automatic, meaning that there can be no bias or uneven process caused by unequal stakes. In PoA, validators need to have their identity verified formally (e.g. via DApps) and have this identity information available in the public domain for everyone to cross-reference.

Proof-of-work (PoW) consensus uses a mining mechanism. PoW can use a mining and computer power-based system in which participating users are required to solve difficult mathematical problems to validate and authenticate transactions. PoW works by verifying that work (mining) has been done before transactions are carried out.

Proof-of-stake (PoS) mechanism works using an algorithm that selects participants with the highest stakes as validators, assuming that the highest stakeholders are incentivized to ensure a transaction is processed. PoS can derives from actual holdings of the cryptocurrency.

Stop-loss order can be a market order to close a position if/when losses reach a threshold.

Extensible Markup Language (XML) is a markup language that defines a set of rules for encoding documents in a format that is both human-readable and machine-readable.

### Exemplary Processes

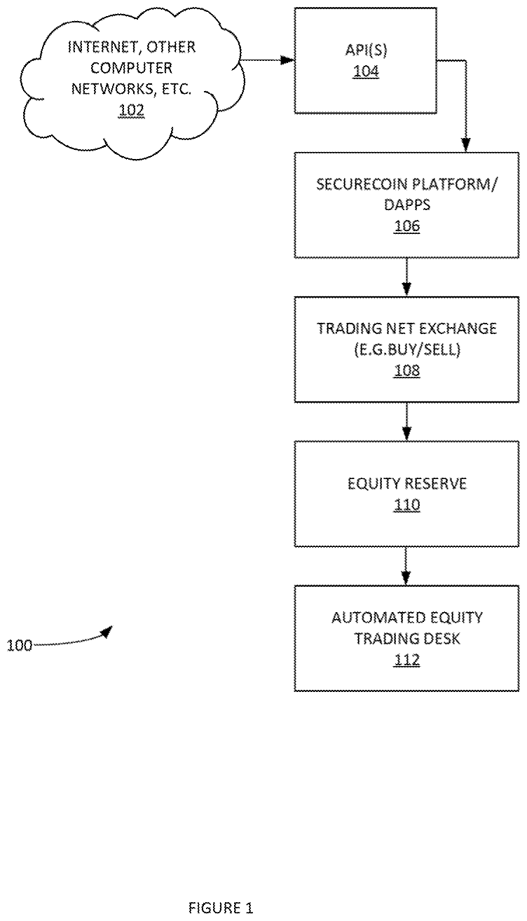

FIG. 1 schematically depicts a security-backed cryptocurrency process 100, according to some embodiments. Process 100 can utilize the Internet 102, APIs 104, etc. to interact with SECURECOIN platform/DAPPS 106. The SECURECOIN can be used on trading/network exchange 108. Equity reserve 110 can back the value of the SECURECOIN. An automated equity trading desk 112 can be implemented. It is noted that SECURECOIN can be a type of cryptocurrency with the attributes provided herein. For example, SECURECOIN can be a cryptocurrency that is backed by a security (e.g. a tradable financial asset such as an S&P 500 stock(s), etc.).

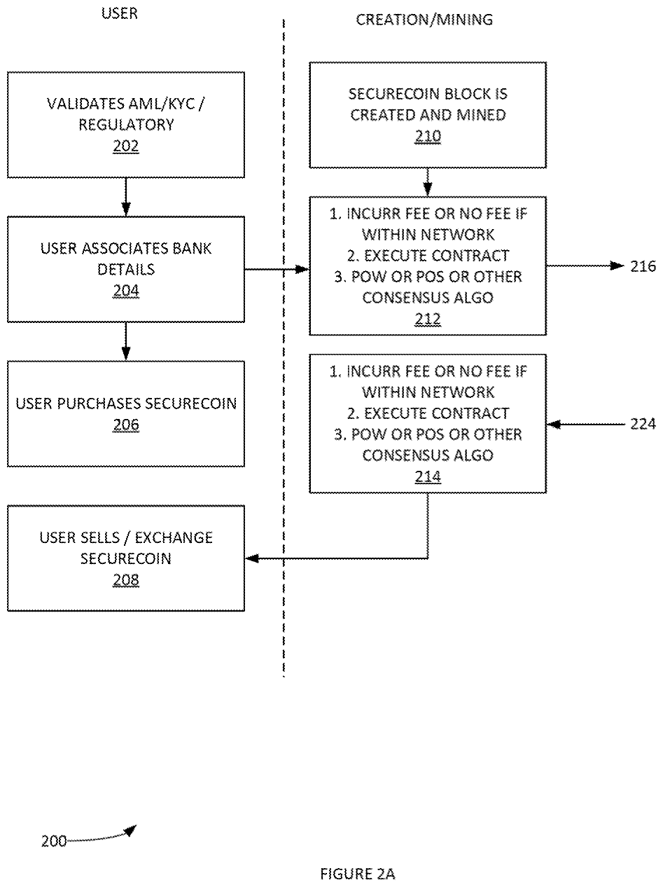

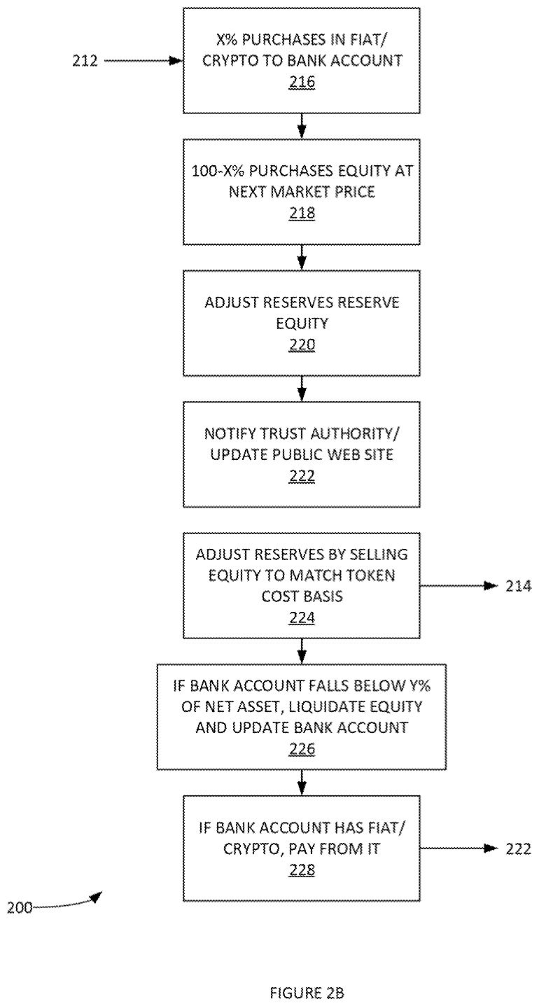

FIGS. 2A-B illustrate an example process 200 of a SECURECOIN flow in a centralized and/or decentralized trading network, according to some embodiments. Process 200 can consist of steps automated by a computing system.

On the user side, in step 202, process 200 can implement various user verifications/registrations (e.g. validates using anti-money laundering (AML) systems, know your client (KYC) systems, etc.) and be associated with a bank account(s). In step 204, enable a user to provide the user's banking account details. In step 206, a user can purchase the SECURECOIN. Process 200 can proceed after step 204 to the SECURECOIN creation/mining portion of process 200.

In step 210, process 200 can generate SECURECOIN using specified block-chain systems. In step 212, process 200 can receive the user information. More specifically, in step 210, process 200 can implement a specific algorithm as shown. For example, step 210 can determine if the user incurs a fee or not (e.g. if the user is within the applicable network). Step 210 can execute the contract for the SECURECOIN purchase. Step 210 can implement a consensus algorithm (e.g. PoW, PoA, PoS, etc.) that is associated with the SECURECOIN. After step 212, process 200 can proceed to step 216.

In step 216, process 200 can deposit a specified percentage (X %) of the purchases in fiat/crypto to a bank account. This can a portion of the SECURECOIN value. For example, if one-hundred dollars of SECURECOIN is purchased, then ten percent can be put as a liquid asset in a reserve holding account (e.g. by a centralized company, a decentralized reserve holding system, etc.). The remaining ninety percent can then be swept out into an applicable equity market.

In step 218, 100−X % of the purchased equity can be set at next market price. In step 220, process 200 can adjust reserves based on reserve equity. In step 222, process 200 can notify a specified trust authority and/or update information on a public web site providing SECURECOIN-related information.

In step 224, process 200 can adjust reserves by selling equity to match a token cost basis. Process 200 can also move to step 214. In step 226, process 200 can detect when a bank account falls below Y % of net asset. When this is detected, step 226 can liquidate a specified equity and update the relevant bank account information (e.g. maintain the 10/90 split of the above example, etc.). In step 228, if bank account has fiat/crypto, then process 200 can pay from it. Process 200 can return to step 222.

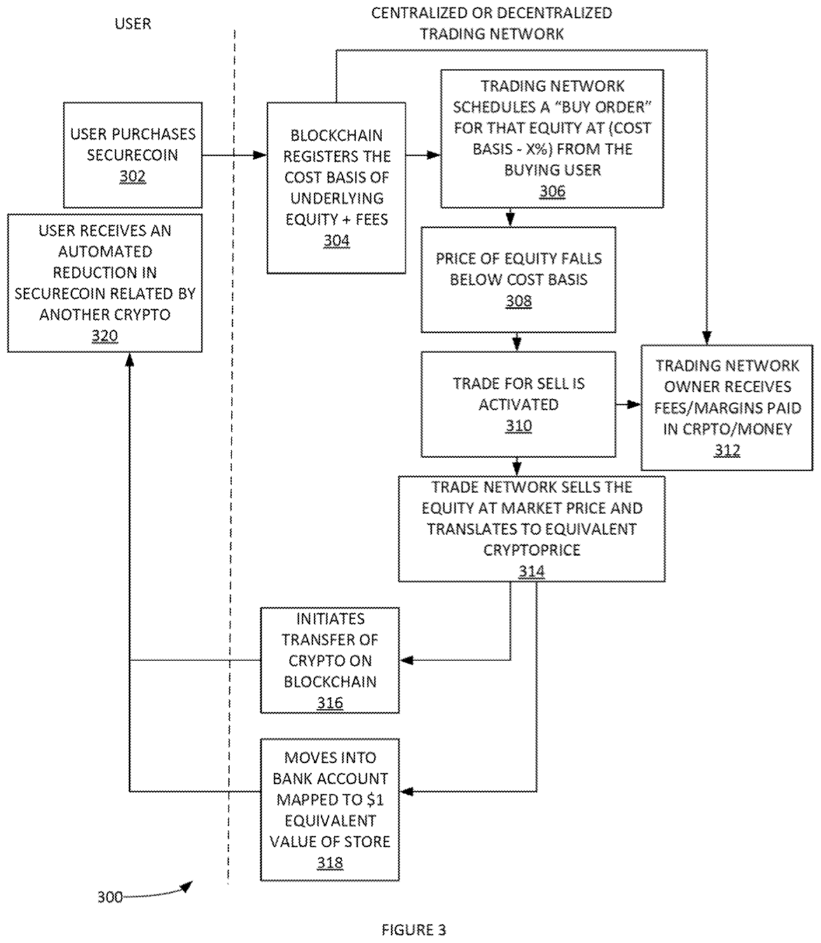

FIG. 3 illustrates an example process 300 for implementing a stop loss order on a secure token/coin (e.g. SECURECOIN, etc.), according to some embodiments. Process 300 can be used to protect the downside risk of a SECURECOIN purchaser.

In step 302, a user purchases SECURECOIN. In step 304, a blockchain system registers the cost basis of underlying equity plus the fees. In step 306, trading network schedules a “buy order” for that equity at (Cost basis−x %) from the buying user. In step 308, process 300 detects that the price of equity fails below cost basis. In step 310, a trade for sell is activated. In step 312, a trading network owner receives fees/margins paid in cryptocurrency and/or money. In step 314, the trade network sells the equity at market price and translates to equivalent cryptocurrency price. In step 316, process 300 initiates transfer of cryptocurrency on the blockchain. In parallel to step 316, instep 318, process 300 moves into bank account mapped to a dollar (and/or other hard currency) equivalent value of the store. In step 320, the user receives an automated reduction in SECURECOIN related by another cryptocurrency.

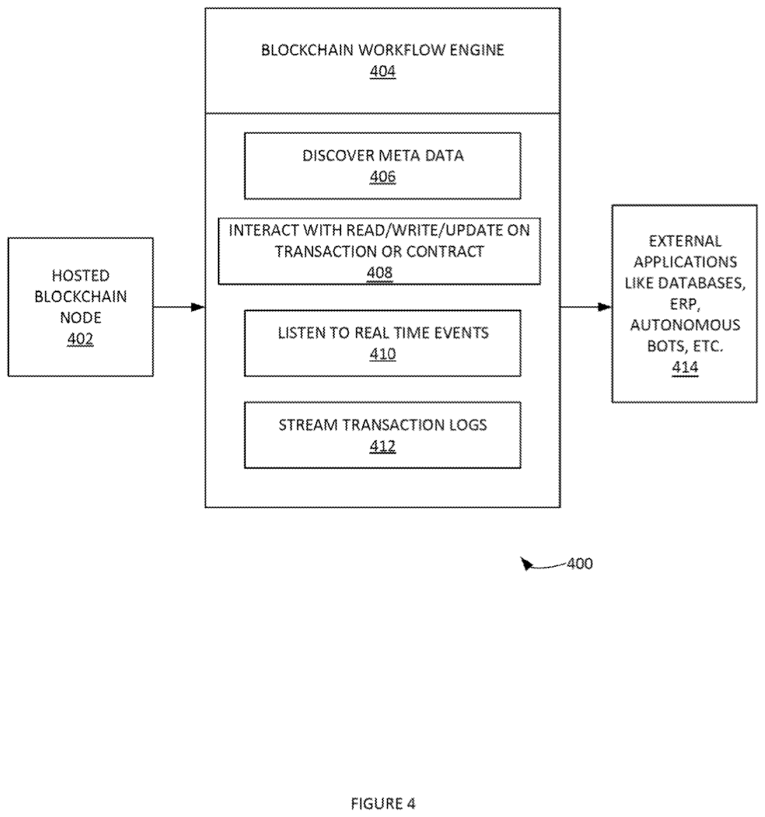

FIG. 4 illustrates an example process 400 for implementing a blockchain workflow engine, according to some embodiments. Blockchain workflow engine 404 can include an integration engine that can read metadata of any blockchain contract. Blockchain workflow engine 404 can query data from a contract globally, public key account or other filters Blockchain workflow engine 404 can write to contract by either interfacing with an external wallet or by storing data within its database. Blockchain workflow engine 404 can listen to events (e.g. a buy order that occurs, a sell that occurs, etc.) on a blockchain globally or by public keys to and transform data to push to another application. This can be done to adjust reserve values.

Blockchain workflow engine 404 can act as a bridge between two (2) or more blockchains to transfer value based on rules or contracts. Blockchain workflow engine 404 can provide the ability to run within a decentralized public network, private, permissioned on any other blockchain network.

Blockchain workflow engine 404 can interface with a hosted blockchain node 402 and external applications 414. External applications 414 can include various modules such as, inter alia: databases, ERP, autonomous bots, etc.

Blockchain workflow engine 404 can include various modules 406-412. These modules can implement blockchain workflows. For example, blockchain workflow engine 404 can discover metadata 406. Blockchain workflow engine 404 can interact with read/write/update operations on transaction or contract 408. Blockchain workflow engine 404 can listen to real time events 410. Blockchain workflow engine 404 can stream transaction logs 412.

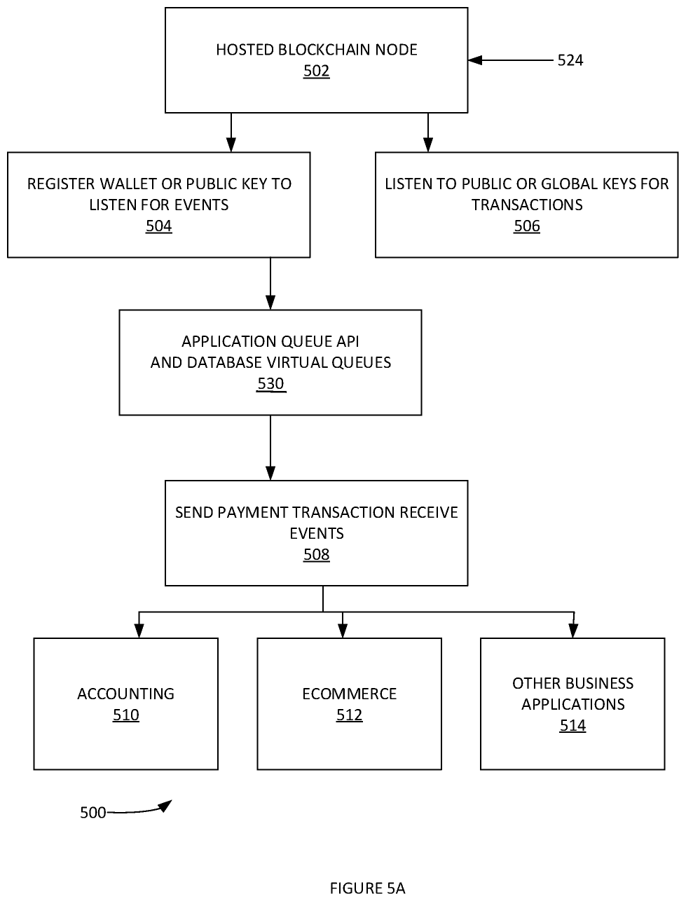

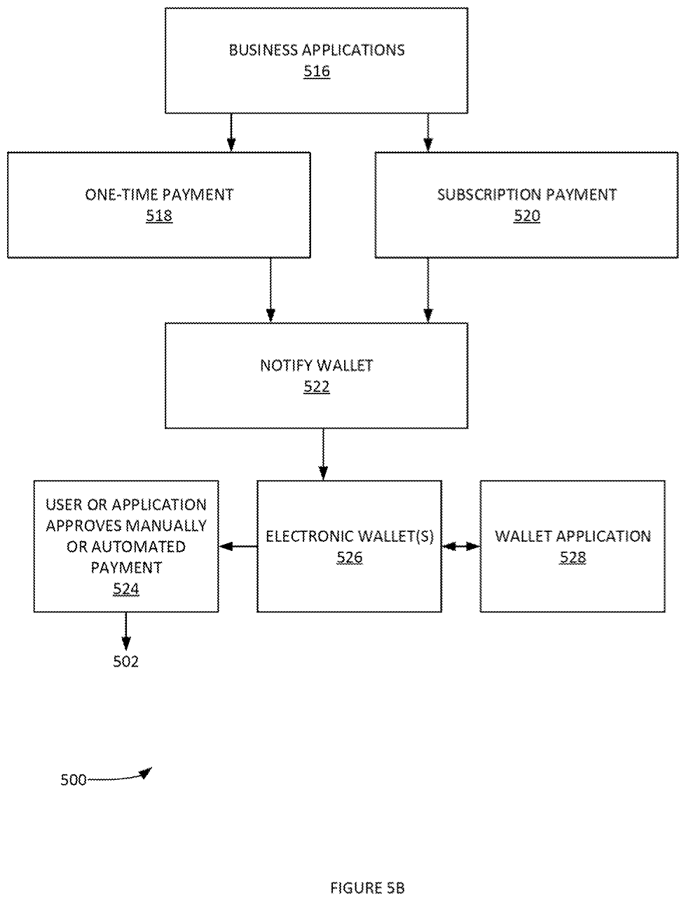

FIGS. 5A-B illustrate an example process 500 for implementing blockchain ERP integration, according to some embodiments. In step 502, process 500 can host a blockchain node. In step 504, process 500 can register wallet or public key to listen for events. In step 506, process 500 can listen to public or global keys for transactions. After step 504, process 500 can proceed to step 508. In step 508, process 500 can send payment transaction receive events. Step 508 can utilize various platforms/applications such as, inter alia: accounting applications 510, ecommerce platforms 512, other business applications, 514.

In step 516, process 500 can implement various business applications. In step 518, process 500 can implement a one-time payment and/or in step 520, process 500 can implement a subscription payment plan. In step 522, a digital wallet can be notified (e.g. using an electronic wallet 526, a wallet application 528, etc.). In step 524, the user or application (manually or automatically) approves payment. Process 500 can return to step 502.

### Example Application Queue API and Database of Virtual Queues

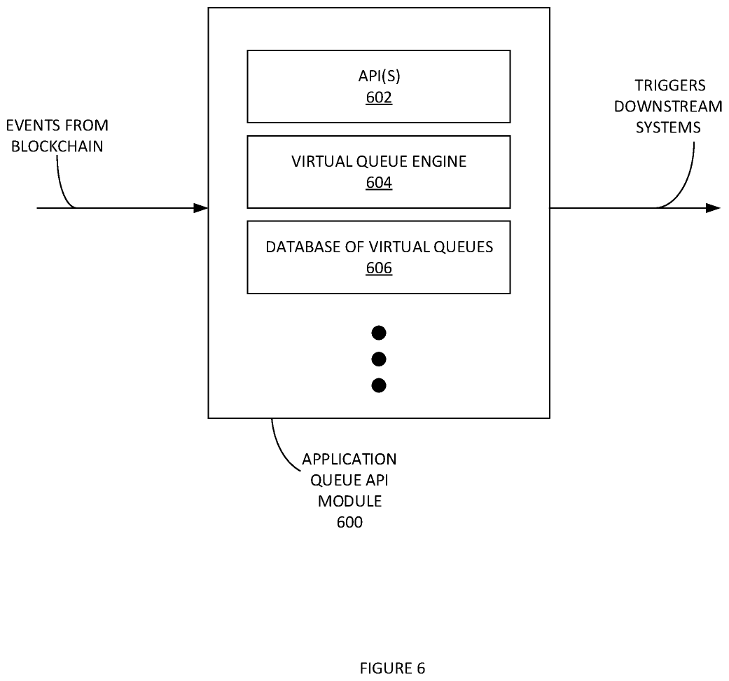

FIG. 6 illustrates an example application queue API module 600, according to some embodiments. Application queue API module 600 can be included in and/or integrated with application queue API and database virtual queues 530 of FIG. 5A supra. Application queue API module 600 can receive digital communications regarding events from one or more blockchains. An event from a blockchain can be received from a registered wallet or public key used to listen for events. Virtual queue engine 604 can then convert the queue/event into a specified file format/data interchange format version. The specified file format/data interchange format version can be in a JSON structure, XML structure and the like.

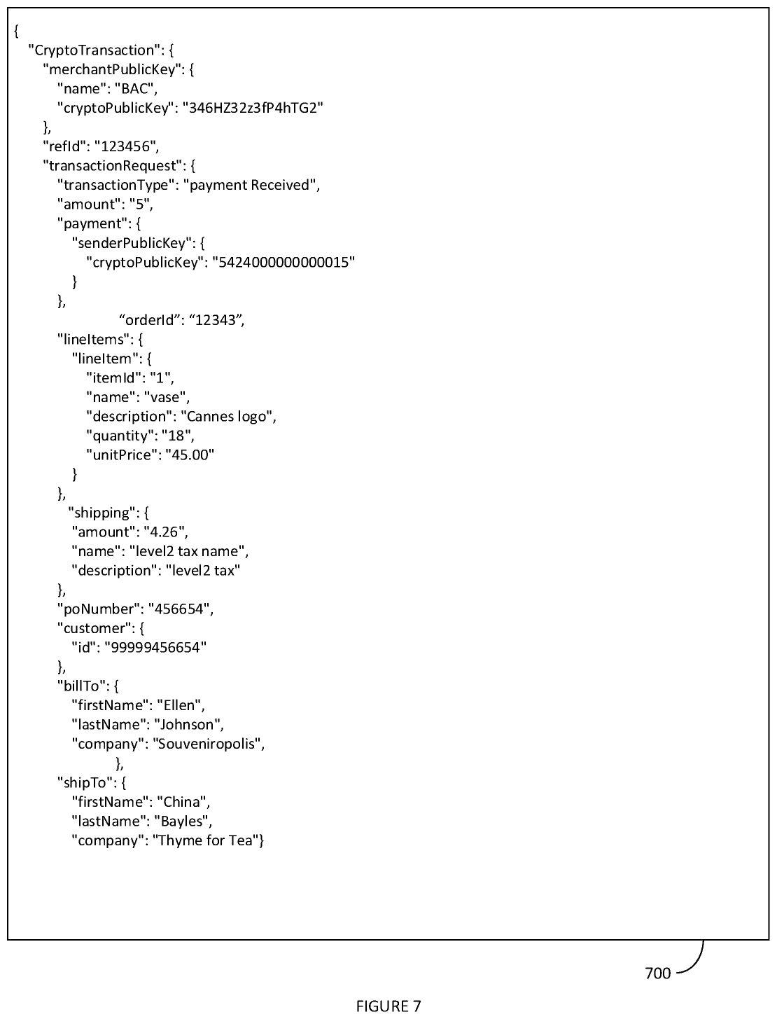

FIG. 7 illustrate an example JSON structure 700 for transferring a blockchain event via an application Queue API, according to some embodiments. The present JSON structure 700 for transferring a blockchain event is similar to credit card process (e.g. instead of a credit card number, etc.). As shown, a queue structure encapsulates all the necessary elements of the transaction from a block chain system (e.g. a decentralized digital currency block chain such a Bitcoin, Ethereum, etc.) to the payment service e.g. sender key, public key, transaction amount, transaction date, other meta data (e.g. audit number), etc. Accordingly, additional elements not shown can be added to the example JSON structure 700.

In one example, an example bicycle repair shot—MIKE'S BIKES—would like to receive payments from in Bitcoin, so it publishes public key in a hosted Bitcoin node. MIKE'S BIKES subscribes to a blockchain ERP system. The blockchain ERP system is able to, instead of a credit-card wrapped, implement a transaction with Bitcoin information. Accordingly, the JSON structure 700 can include, inter alia, a reference number of cryptocurrency transaction key, request that received payment, payment amount, identity of who sent the payment, line items of invoice/order identifier, destination to be shipped to, etc. The JSON structure 700 can also include, inter alia: a customer number, other metadata, various user defined fields, etc. The the JSON structure 700 can be inserted into a queue and its information pushed into any account in a payment service system and/or integrated into said payment service system. JSON structure 700 can include various open-source blockchain extensions (e.g. use Ethereum extensions, etc.).

Returning to FIG. 6, application queue API module 600 can include database of virtual queues 606. When application queue API module 600 triggers an event in a downstream system, the downstream system can access the relevant JSON structure structure(s) stored in database of virtual queues 606.

It is noted that the systems and methods provided herein can enable a blockchain workflow engine to communicate with a blockchain node. Accordingly, the systems and methods can discover metadata and interface with the blockchain so that they can automatically read, write, and listen to event logs and stream logs. The methods and systems can provide the ability to discover metadata and read and write based on metadata of Bitcoin (e.g. and/or Ethereum with meta data extensions, etc.).

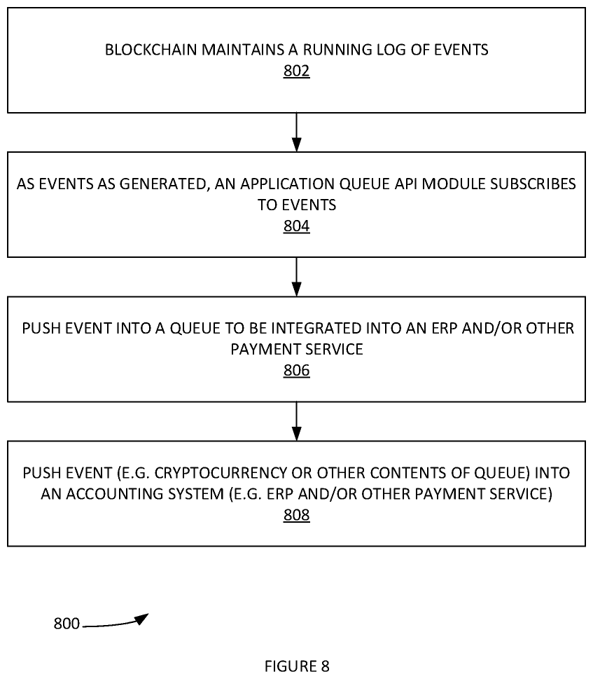

FIG. 8 illustrates an example process 800 for implementing an application queue API, according to some embodiments. In step 802, a blockchain(s) maintains a running log of events. In step 804, as these events as generated, an application queue API module can subscribe to events. For example, an application queue API module can subscribe to event on a Bitcoin blockchain. Application queue API module can translate the event to a JSON structure (and/or other applicable format such as XML and the like). A user or other entity can have a bitcoin account and can register and receive money with Bitcoin via the application queue API module. The application queue API module can listen to an event from the Bitcoin blockchain. In step 806, the application queue API module can push the event into a queue to be integrated into an ERP and/or other payment service. The queues of the application queue API module are holders of the event. As noted supra, a queue/event can be a JSON structure, XML structure and the like.

For example, application queue API module can store a Bitcoin transaction in its queue (e.g. in an intermediate storage). The application queue API module can trigger applicable downstream systems to implement a specified action (e.g. activating a license, receiving a blockchain-based payment, etc.). In the blockchain-based payment example, application queue API module can, step 808, push the cryptocurrency (or other block chain event) into an accounting system. It is noted that payment systems can have their own internal APIs (e.g. Bill.com, etc.). These can receive the events and route the event to an applicable accounting system, e-commerce system, business application, escrow system, etc. The payment service system can be a payment processor.

In one example, a payment service can have an API and/or an EDI document (e.g. if a business application, etc.). Process 800 uses queues to ensure that incoming events are not lost. Process 800 can encrypt queues as well.

Process 800 can utilize an electronic wallet. Process 800 can receive a block chain identifying number. The electronic wallet can be used to identify an identity of a sender from the block chain (e.g. a cryptocurrency payment, a blockchain-based contract, etc.). The queues implemented by process 800 can receive payments into the system (e.g. as shown in FIGS. 5A-B and/or FIG. 6, etc.). Process 800 can be used to send payments to an entity. Process 800 can push a payment from the electronic wallet to a payment system. The payment system then submits the payment to a blockchain. Accordingly, the payment is received in the process 800 queue. The payment is rerouted from the queue to a payment service system on the backend. In this way, process 800 enables an integration of a blockchain with a financial system(s).

### Example Computing Systems

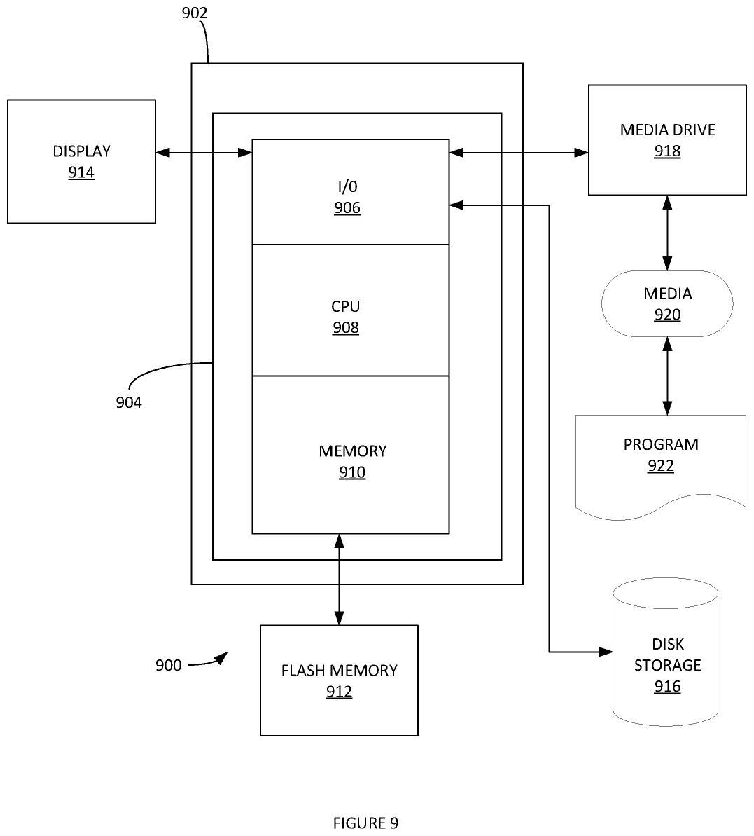

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. In another example, computing system 900 can be configured as a mobile device and include such systems as may be typically included in a mobile device such as GPS systems, gyroscope, accelerometers, cameras, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A system for processing a real-time resource transfer using distributed ledger technology utilizing an application queue application programming interface (API) and a database virtual queues, the system comprising:
a first entity node comprising:
a first processor;
a first communication interface; and
a first memory having a portion of a blockchain application stored therein, wherein the blockchain application comprises a blockchain comprising a plurality of data records, wherein the blockchain application, when executed by the processor, causes the processor to:
generate a blockchain event related to the users banking account details; and
maintain in the blockchain a running log of events comprising the blockchain event;
a second entity node comprising:
a second processor;
a second communication interface; and
a second memory having an application queue API module stored therein, wherein the application queue API module, when executed by the processor, causes the processor to:
provide an API available to the first communication interface of the first entity node comprising the blockchain;
subscribe to the log of blockchain events, via the first communication interface;
with the application queue API module, translates the blockchain event into a standardized data interchange format version of the block chain event; and
store the standardized data interchange format version of the block chain event in a database of virtual queues accessible by an external computing entity via the second interface.

2. The system of claim 1, wherein the application queue API module translates the blockchain event to a JSON structure.

3. The system of claim 1, wherein the application queue API module translates the blockchain event to an Extensible Markup Language (XML) structure.

4. The system of claim 1, wherein the block chain event comprises a cryptocurrency transfer to a digital wallet managed by the external computing entity.

5. The system of claim 4, wherein the first memory having a blockchain application stored therein, wherein the blockchain application comprises a blockchain comprising a plurality of data records, wherein the blockchain application, when executed by the processor, further causes the processor to:
generate a cryptocurrency, wherein the cryptocurrency is generated by a specified block-chain system;
determine that the user has purchased a portion of the cryptocurrency; and
deposit a specified percentage of the purchase of the cryptocurrency in a bank account.

6. The system of claim 5, wherein the cryptocurrency comprises a Bitcoin-based cryptocurrency.

7. The system of claim 5, wherein the second memory having the application queue API module stored therein, wherein the application queue API module, when executed by the processor, further causes the processor to:
receive a query from the external computing entity, wherein the query comprises a request for a cryptocurrency transaction in the block chain;
communicate the standardized data interchange format version of the cryptocurrency transaction to the external computing entity.

8. The system of claim 7, wherein the external computing entity comprises an entity that manages a digital wallet of the user.

9. The system of claim 7, wherein application queue API module triggers the external computing entity to activate a software application license based on the block chain event.

10. The system of claim 9, wherein the JSON structure include various open-source blockchain extensions (e.g. use Ethereum extensions, etc.).

11. The system of claim 10, wherein the JSON structure includes a block chain identifying number.

12. The system of claim 11, wherein the electronic wallet is be used to identify an identity of a sender identity from the block chain.

13. The system of claim 12, wherein the JSON structure comprises an open-source blockchain extension.

14. The system of claim 13, wherein the open-source blockchain extension comprises an Ethereum extension.
